(19) United States
(12) Patent Application Publication
(10) Pub. No.: US 2023/0376964 A1
(43) Pub. Date: Nov. 23, 2023

(54) SYSTEMS AND METHODS FOR DETECTING UNAUTHORIZED ONLINE TRANSACTIONS

(71) Applicant: GEN DIGITAL INC., TEMPE, AZ (US)

(72) Inventors: Kevin Alejandro Roundy, El Segundo, CA (US); Iskander Sanchez Rola, Antibes (FR); Goutham Kumar Nekkalapu, San Jose, CA (US); Emory Shing-Kuo Shyong, Fremont, CA (US); Platon Kotzias, Athens (GR); Magesh Varadharajan, Sunnyvale, CA (US)

(21) Appl. No.: 17/805,629

(22) Filed: Jun. 6, 2022

(30) Foreign Application Priority Data
May 23, 2022 (EP) 22386031.3

(51) Int. Cl. G06Q 20/40; G06Q 20/16

(52) U.S. Cl. CPC G06Q 20/4016; G06Q 20/16

(57) ABSTRACT

The disclosed computer-implemented method for detecting unauthorized online transactions may include correlating, by at least one processor, one or more reported financial activities to one or more online financial activities tracked in network telemetry on one or more authorized devices. The method may additionally include identifying, by the at least one processor based on the correlation, at least one of the reported financial activities that was initiated by an unauthorized device. The method may also include performing, by the at least one processor, a security action in response to the identification. Various other methods, systems, and computer-readable media are also disclosed.

### CROSS-REFERENCE TO RELATED APPLICATION

This application claims priority to European patent application no. EP22386031.3, which was filed on May 23, 2022, and titled “SYSTEMS AND METHODS FOR DETECTING UNAUTHORIZED ONLINE TRANSACTIONS,” and the entirety of this application is incorporated herein.

### BACKGROUND

Legitimate online transactions initiated by individuals using their own devices are difficult to distinguish from fraudulent transactions initiated by criminals with stolen financial accounts. Most financial and security organizations do not have an adequate viewpoint from which to clearly distinguish the two. Criminals employ a wide variety of methods to steal financial account details, such as credit card skimming, physical credit card or bank card theft, phishing and other untrustworthy websites, data breaches, online account credential theft, sim swapping attacks followed by account reset, etc. With these account details they can then easily initiate fraudulent online transactions.

When antivirus and security software is installed on a consumer's device, it provides a viewpoint from which legitimate online transactions can be observed. In particular, antivirus and security software products provide visibility into web traffic. For example, such products may include browser extensions that analyze websites visited and detect viruses, spyware, malware, or other online threats. As another example, such products may include an iOS security product which registers as a VPN. However, such products provide no visibility into fraudulent transactions that are not initiated on protected devices.

On the other hand, systems and services that monitor for identity theft, the use of personal information, and credit score changes can monitor all of a user's financial transactions, but cannot readily distinguish between transactions that occurred on an account owner's device and a criminal's device.

The present disclosure, therefore, identifies and addresses a need for systems and methods for detecting unauthorized online transactions.

### SUMMARY

As will be described in greater detail below, the present disclosure describes various systems and methods for detecting unauthorized online transactions.

In one example, a method for detecting unauthorized online transactions may include correlating, by at least one processor, one or more reported financial activities to one or more online financial activities tracked in network telemetry on one or more authorized devices. The method may additionally include identifying, by the at least one processor based on the correlation, at least one of the reported financial activities that was initiated by an unauthorized device. The method may also include performing, by the at least one processor, a security action in response to the identification.

In some implementations of the method, the one or more reported financial activities may correspond to one or more card-not-present financial transactions of an account. Also, the one or more online financial activities may correspond to one or more web-based financial transactions tracked in network telemetry on at least one of the authorized devices. Such authorized devices may be authorized to perform online purchases using the account.

In some implementations of the method, the one or more reported financial activities may correspond to one or more new accounts appearing on a credit report of a user. Also, the one or more online financial activities may correspond to one or more account opening activities tracked in network telemetry on at least one of the authorized devices. Such authorized devices may be authorized to open new accounts on behalf of the user.

In some implementations of the method, the method may further include tracking the one or more online financial activities on at least one of the authorized devices that is authorized to perform the online financial activities.

In some implementations of the method, the method may further include identifying the one or more reported financial activities.

In some implementations of the method, the method may further include filtering, from the one or more reported financial activities, at least one of automated recurring transactions or transactions that do not correspond to card-not-present transactions.

In some implementations of the method, performing the security action may include at least one of issuing an alert or taking a preventative action. In some of these implementations of the method, issuing the alert may include at least one of generating an alert in response to the identifying or issuing a potential fraud alert generated based on a fraud detection analysis of the one or more reported financial activities. Additional or alternatively, taking the preventative action may include at least one of placing a hold on an account or performing an automated credit freeze.

In one embodiment, a system for detecting unauthorized online transactions may include at least one physical processor and physical memory that includes computer-executable instructions that, when executed by the physical processor, cause the physical processor to correlate one or more reported financial activities to one or more online financial activities tracked in network telemetry on one or more authorized devices. The instructions may additionally cause the physical processor to identify, based on the correlation, at least one of the reported financial activities that was initiated by an unauthorized device. The instructions may additionally cause the physical processor to perform a security action in response to the identification.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to correlate one or more reported financial activities to one or more online financial activities tracked in network telemetry on one or more authorized devices. The instructions may additionally cause the computing device to identify, based on the correlation, at least one of the reported financial activities that was initiated by an unauthorized device. The instructions may further cause the computing device to perform a security action in response to the identification.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for detecting unauthorized online transactions.

FIG. 2 is a block diagram of an additional example system for detecting unauthorized online transactions.

FIG. 3 is a flow diagram of an example method for detecting unauthorized online transactions.

FIG. 4 is a system block diagram illustrating an example system for detecting unauthorized online transactions.

FIG. 5 is a system block diagram illustrating an example system for detecting unauthorized online transactions.

FIG. 6 is a system block diagram illustrating an example system for detecting unauthorized online transactions.

FIG. 7 is a system block diagram illustrating an example system for detecting unauthorized online transactions.

FIG. 8 is a block diagram of an example computing system capable of implementing one or more of the embodiments described and/or illustrated herein.

FIG. 9 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to systems and methods for detecting unauthorized online transactions. As will be explained in greater detail below, by correlating reported financial activities to online financial activities tracked in network telemetry on authorized devices, reported financial activities initiated by unauthorized devices may be identified. The proposed systems and methods may respond to these identifications by performing security actions.

In addition, the systems and methods described herein may improve the functioning of a computing device by enabling the computing device to detect unauthorized online transactions and take measures to protect users. The improved detection may be a more rapid detection and/or a more accurate detection. Security actions may allow for rapid and/or automated alerts, fraud confirmations, account locks, charge reversals, and/or credit freezes. Some embodiments further allow improved user control of automated security measures by expressing user preferences on a basis that is specific to an account, device, and/or correlation type.

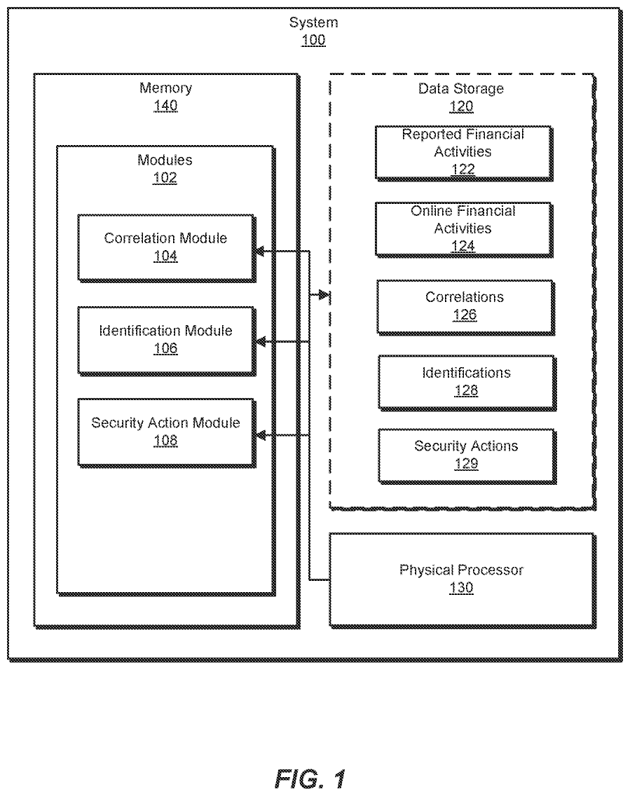

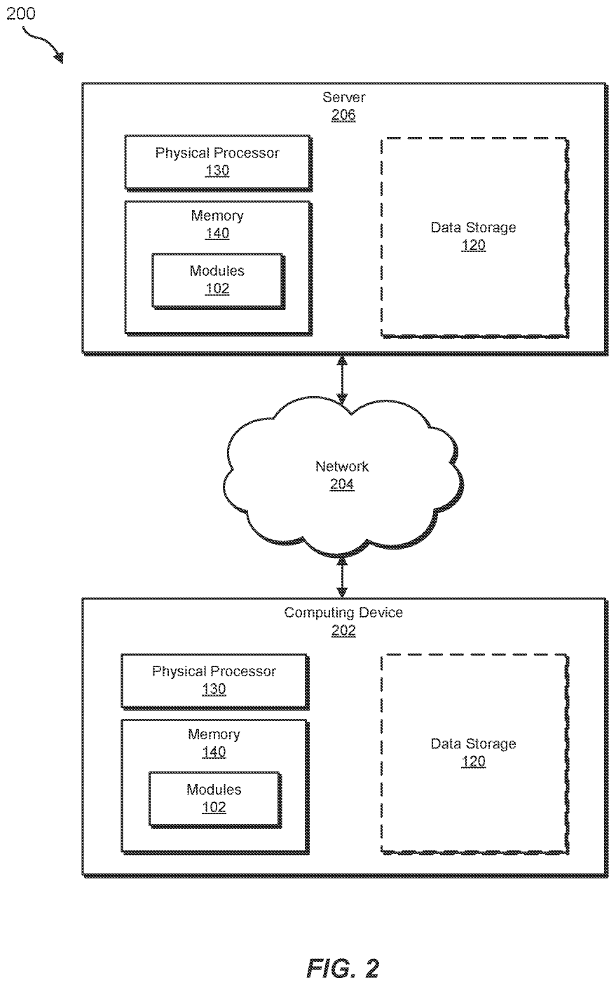

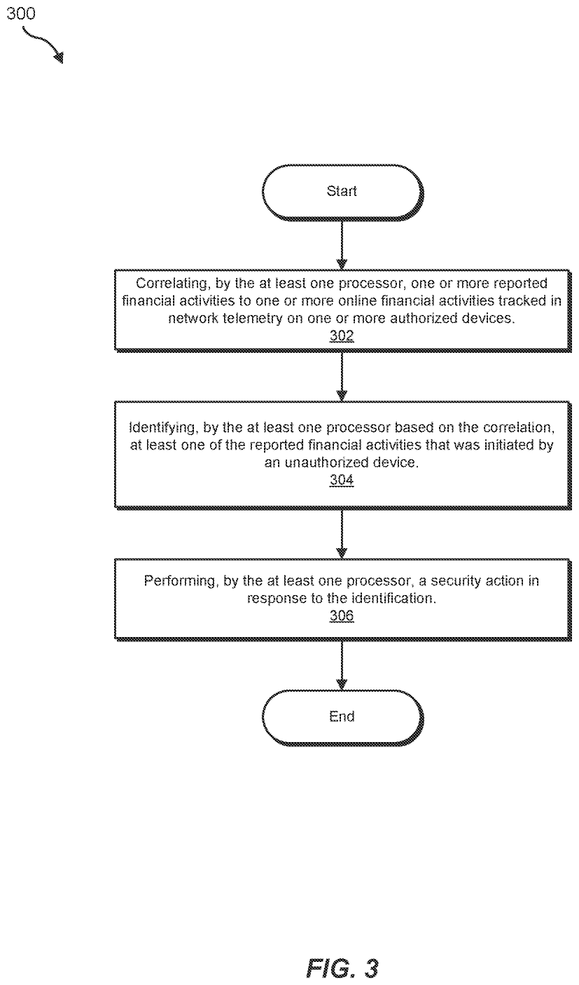

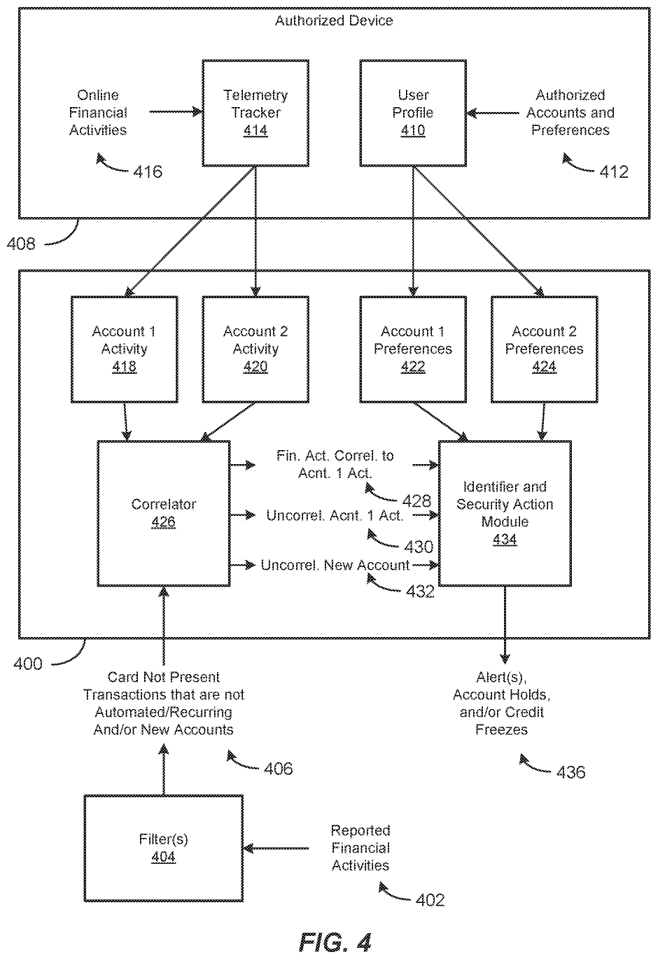

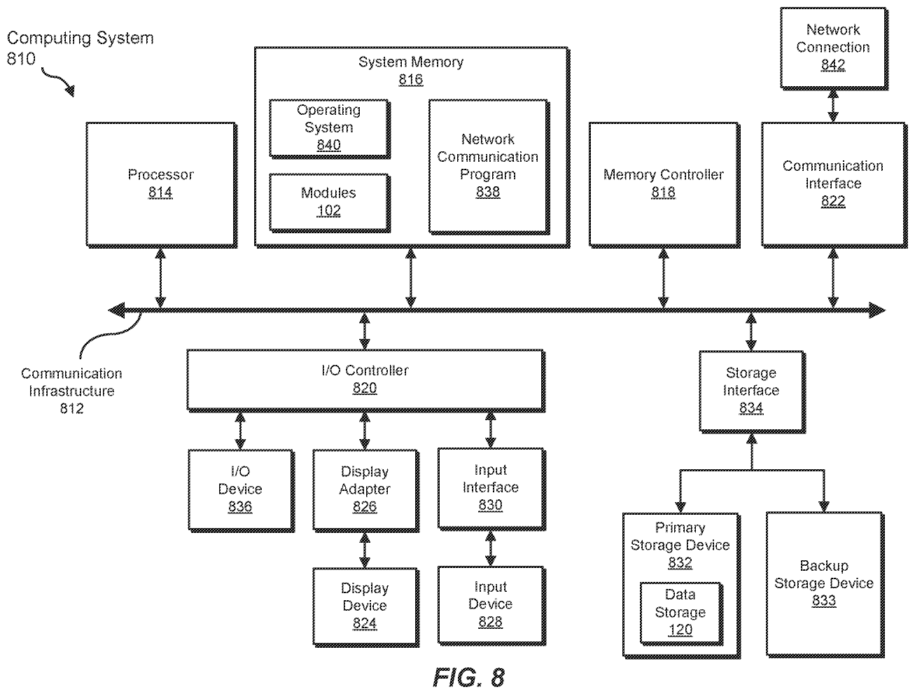

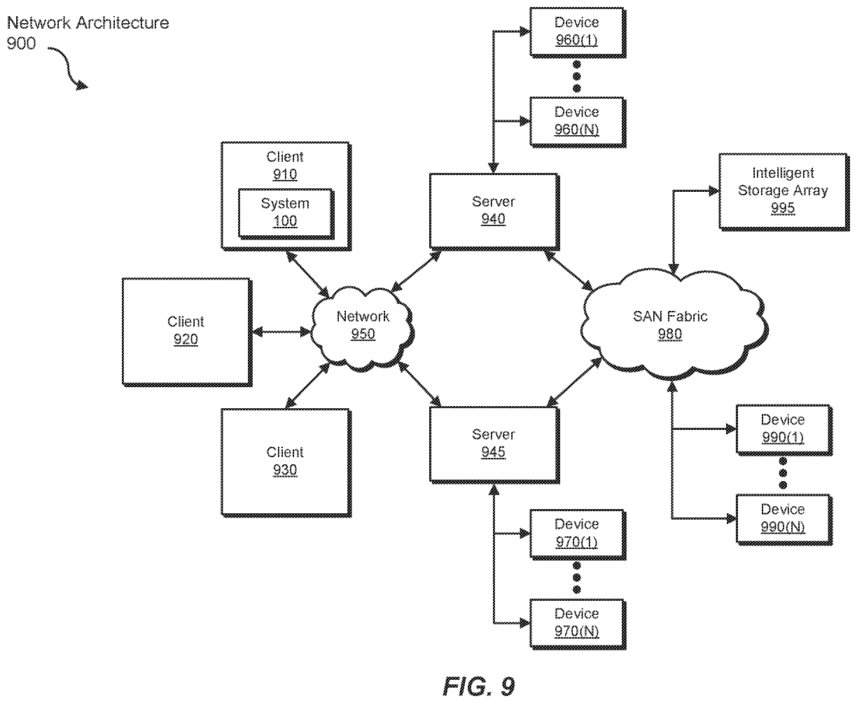

The following will provide, with reference to FIGS. 1-2, detailed descriptions of example systems for detecting unauthorized online transactions. Detailed descriptions of corresponding computer-implemented methods will also be provided in connection with FIG. 3. Detailed descriptions of example systems for detecting unauthorized online transactions will further be provided in connection with FIGS. 4-7. In addition, detailed descriptions of an example computing system and network architecture capable of implementing one or more of the embodiments described herein will be provided in connection with FIGS. 8 and 9, respectively.

FIG. 1 is a block diagram of an example system 100 for detecting unauthorized online transactions. As illustrated in this figure, example system 100 may include one or more modules 102 for performing one or more tasks. As will be explained in greater detail below, modules 102 may include a correlation module 104, an identification module 106, and a security action module 108. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate detecting unauthorized online transactions. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, example system 100 may also include one or more information repositories, such as data storage 120. Data storage 120 generally represents any type or form of stored data. In one example, data storage 120 may include databases, spreadsheets, tables, lists, matrices, trees, or any other type of data structure. Examples of data storage 120 include, without limitation, reported financial activities 122, online financial activities 124, correlations 126, identifications 128, and/or security actions 129.

Example system 100 in FIG. 1 may be implemented in a variety of ways. For example, all or a portion of example system 100 may represent portions of example system 200 in FIG. 2. As shown in FIG. 2, system 200 may include a computing device 202 in communication with a server 206 via a network 204. In one example, all or a portion of the functionality of modules 102 may be performed by computing device 202, server 206, and/or any other suitable computing system. As will be described in greater detail below, one or more of modules 102 from FIG. 1 may, when executed by at least one processor of computing device 202 and/or server 206, enable computing device 202 and/or server 206 to detect unauthorized online transactions. For example, and as will be described in greater detail below, one or more of modules 102 may cause computing device 202 and/or server 206 to correlate one or more reported financial activities to one or more online financial activities tracked in network telemetry on one or more authorized devices. Additionally, one or more of modules 102 may cause computing device 202 and/or server 206 to identify, by the at least one processor based on the correlation, at least one of the reported financial activities that was initiated by an unauthorized device. Additionally, one or more of modules 102 may cause computing device 202 and/or server 206 to perform, by the at least one processor, a security action in response to the identification.

Computing device 202 generally represents any type or form of computing device capable of reading computer-executable instructions. For example, computing device 202 may be any computer that is capable of receiving and analyzing input data to produce output data according to the instructions. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Server 206 generally represents any type or form of computing device that is capable of receiving and analyzing input data to produce output data according to the instructions. Additional examples of server 206 include, without limitation, security servers, application servers, web servers, storage servers, and/or database servers configured to run certain software applications and/or provide various security, web, storage, and/or database services. Although illustrated as a single entity in FIG. 2, server 206 may include and/or represent a plurality of servers that work and/or operate in conjunction with one another.

Network 204 generally represents any medium or architecture capable of facilitating communication or data transfer. In one example, network 204 may facilitate communication between computing device 202 and server 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

FIG. 3 is a flow diagram of an example computer-implemented method 300 for detecting unauthorized online transactions. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 302 one or more of the systems described herein may correlate, by at least one processor, one or more reported financial activities to one or more online financial activities tracked in network telemetry on one or more authorized devices. For example, correlation module 104 may, as part of computing device 202 in FIG. 2, correlate reported financial activities 122 to one or more online financial activities 124, resulting in correlations 126 (i.e., correlation results).

The term “network telemetry,” as used herein, generally refers to collection of information from various data sources using a set of automated communication processes, transmitted to receiving equipment for analysis tasks. For example, and without limitation, network telemetry may include PFIX (NetFlow) records, VPC flow logs, packet mirroring, cloud IDS, and network forensics and telemetry blueprint.

The term “correlate,” as used herein, generally refers to creating a record that two things have a mutual relationship or connection, in which one thing affects or depends on the other. For example, and without limitation, a correlation may be a positive correlation, a negative correlation, or no correlation.

The term “reported financial activity,” as used herein, generally refers to a record of a financial transaction or new account appearing on an account statement or credit report. For example, and without limitation, reported financial activity may include a purchase, a payment, a money transfer, a deposit, an application for credit, and/or opening of a new account.

The term “authorized devices,” as used herein, generally refers to any computing device capable of running anti-virus and security software, browsing the internet, and performing financial transactions online. For example, and without limitation, authorized devices, may include desktop computers, laptops, tablets, and/or smartphones.

Correlation module 104 may perform the correlation in a variety of ways. For example, correlation module 104 may correlate one or more card-not-present financial transactions of an account to one or more web-based financial transactions tracked in network telemetry on one or more devices authorized to perform online purchases using the account. Alternatively or additionally, correlation module 104 may, as part of computing device 202 in FIG. 2, correlate one or more new accounts appearing on a credit report of a user to one or more account opening activities tracked in network telemetry on one or more devices authorized to open new accounts on behalf of the user.

At step 304, one or more of the systems described herein may identify, by the at least one processor based on the correlation, at least one of the reported financial activities that was initiated by an unauthorized device. For example, identification module 106 may, as part of computing device 202 in FIG. 2, detect reported financial activities initiated by an unauthorized device.

Identification module 106 may perform the identification in a variety of ways. For example, identification module 106 may filter, from the one or more reported financial activities, at least one of automated recurring transactions or transactions that do not correspond to card-not-present transactions. This filtering may be performed before and/or after the correlation at step 302. Additionally or alternatively, identification module 106 may identify reported financial activities as being initiated by an unauthorized device in response to those activities failing to correlate to any of the online financial activities. Additionally, identification module 106 may identify reported financial activities as being initiated by an unauthorized device in response to such activities that correlate to online financial activities but that violate user preferences for an associated account, an associated device, and/or an associated type of activity.

The term “filter,” as used herein, generally refers to application of one or more rule or logic to identify cases of data that should be included in an analysis. For example, and without limitation, a filter may look at results for a particular period of time, calculate results for particular groups of interest, exclude erroneous or “bad” observations from an analysis, and/or train and validate statistical models.

The term “user preferences,” as used herein, generally refers to configurable settings that can be customized for a particular user. For example, and without limitation, user preferences may be persistently stored settings, dynamically updated settings, specifically provided settings, and/or heuristically learned settings.

At step 306, one or more of the systems described herein may perform, by the at least one processor, a security action in response to the identification. For example, security action module 108 may, as part of computing device 202 in FIG. 2, perform a security action.

The term “security action,” as used herein, generally refers to a computer output responsive to an input indicative of a security concern, taken as a security measure. For example, and without limitation, a security action may be an alert or a preventative action.

Security action module 108 may perform the security in a variety of ways. For example, security action module 108 may issue an alert or take a preventative action. Issuing the alert may include generating an alert in response to the identifying and/or issuing a potential fraud alert generated based on a fraud detection analysis of the one or more reported financial activities. Alternatively or additionally, taking the preventative action may include placing a hold on an account and/or performing an automated credit freeze.

The term “alert,” as used herein, generally refers to a message indicative of a security concern. For example, and without limitation, an alert may communicate the security concern in any suitable manner, such as voice call, text message, email, pop up in an application or browser, etc.

The term “preventative action,” as used herein, generally refers to a measure taken to remediate a security concern. For example, and without limitation, preventative actions may include account holds, charge reversals, and/or credit freezes.

The term “account hold,” as used herein, generally refers to a restriction on an account owner's ability to access funds in an account due to various reasons. For example, and without limitation, account holds may include temporary holds, balance holds, or check holds.

The term “credit freeze,” as used herein, generally refers to a security freeze that prevents prospective creditors from accessing a credit file. For example, and without limitation, credit freezes may include free credit freezes, credit locks, and fraud alerts.

Steps 302-306 may further include one or more additional activities. For example, when the disclosed systems and methods are implemented on the cloud, they may be carried out separately from the telemetry tracking and/or the identification or filtering of one or more reported financial activities. However, some realizations of the disclosed systems and methods may be implemented on board one or more authorized devices. In such cases, one or more of steps 302-306 may further include tracking the one or more online financial activities on at least one of the authorized devices that is authorized to perform the online financial activities. In alternative or additional realizations, the disclosed systems and methods may be implemented at a server and/or service of an entity that monitors for identity theft, the use of personal information, and credit score changes. In such implementations, one or more of steps 302-306 may further include identifying the one or more reported financial activities (e.g. filtering).

FIG. 4 illustrates an example system 400 for detecting unauthorized online transactions. Reported financial activities 402 may be processed by filters 404 to produce filter results 406, such as card-not-present transactions that are not automated/recurring transactions and/or new accounts. Financial transaction reports may have a bit for each transaction that indicates if the transaction is a card-not-present transaction, which enables identification of in-person transactions. The filtering may be performed based on a setting of such a bit.

Financial transaction reports may also have a description for each transaction that typically includes domain names and is usually accompanied by detailed information about the merchant. Identifying online transactions among all of the not in-person transactions (i.e., card-not-present) may require some intelligence. In particular, the filters 404 may filter out recurring transactions (e.g., monthly utility bill payments), bank transfers, payments via checks, and over-the-phone payments. These transactions, while not physical, are unlikely to appear in the user's web traffic. Most of these transactions that lack an online counterpart can be filtered out based on existing transaction category markers. However, detecting recurring transactions is more challenging. For instance, in the case of a home's electricity bill, users are likely to have set up an auto-payment plan that will not have a corresponding website visit. In this case, the system 400 may issue an alert for the first instance of a bill payment if not initiated from a trusted device, but then avoid issuing alerts for subsequent charges which are likely to occur automatically. To accomplish this behavior, a recurring charges detection procedure may be used to eliminate recurring transactions that happen on a periodic basis, as these charges are unlikely to correlate to website visits and are unlikely to be of interest. Reliability of this detection method may be increased by looking across users to identify merchants that routinely charge users on a recurrent basis.

An authorized device 408 may have a user profile 410 that records authorized accounts and user preferences 412 that may be collected by a user interface of antivirus and security software installed on authorized device 408. Authorized device 408 may also have a telemetry tracker 414 that tracks online financial activity 416 performed using the authorized device. For example, telemetry tracker 414 may be implemented as part of a browser extension and/or VPN of the antivirus and security software installed on authorized device 408.

Antivirus and security software installed on authorized device 408 (e.g., PCs and laptops) may contain network engines and web-browser extensions that enable the antivirus and security software to view web traffic. By monitoring website visits, and more specifically identifying instances in which customers are initiating financial transactions through the browser, the antivirus and security software may collect a list of visited websites, timestamps, and dollar amounts of any transactions conducted through those websites. Similarly, on iOS devices, the antivirus and security software may register as a VPN so that it can identify malicious traffic. This same service can provide insight into any domains visited through which financial transactions may have been processed, and associate these with timestamps. Antivirus and security software users may have a single antivirus and security software account with multiple licenses that they use to protect their trusted devices. The antivirus and security software may, thus, have a sense of which devices the user trusts, though users may be able to further designate which of these devices they trust to make purchases.

In an example, in order to differentiate a visit to Amazon.com and a purchase in Amazon.com, the antivirus and security software may examine the network requests that are triggered while browsing the website. A first step may be to use telemetry to understand which requests signal a buy. This operation may be accomplished using browser-based sources of telemetry to identify the requests that occur after a user inserts credit card information on a web form. With this knowledge, the antivirus and security software may create patterns of requests, related to purchases, that allow example system 400 to later determine when purchases are performed by examining network traffic even when the network traffic is collected without the extra visibility provided by a browser extension (e.g., interception of traffic on an iOS device).

Example system 400 may receive and store account activity 418 and 420 from telemetry tracker 414. Example system 400 may also receive and store account preferences 422 and 424 from user profile 410. A correlator 426 of example system 400 may further receive and process filter results 406 to produce correlation results 428-432. The correlation procedure may be carried out, for example, by matching merchant information of filter results 406 to domain names of account activity 418 and 420. Additionally or alternatively, the correlation may be carried out using fuzzy matching between online transactions on authorized devices and reported financial transactions occurring in a similar time period.

Correlation results 428-432 may involve one or more attributes, such as time of the web site purchase of account activity 418 and 420 observed by telemetry tracker 414 matched with time of a reported financial transaction of filter results 406. Another attribute of correlation results 428-432 may include a domain name, title, and/or level-1 headers matched with a description and merchant details of a reported financial transaction of filter results 406. Yet another attribute of correlation results 428-432 may include a financial account used for a website purchase of account activity 418 and 420 observed by telemetry tracker 414 matched with a financial account associated with the reported financial transaction of filter results 406. A further attribute of correlation results 428-432 may include a description of a product and/or service associated with a web site purchase of account activity 418 and 420 observed by telemetry tracker 414 matched with a description of a reported financial transaction of filter results 406. The fuzzy matching technique may be made more tractable by relying on correlations between multiple users who are making similar transactions on popular sites, which enables detection of common patterns and elimination of spurious correlations.

In the example of FIG. 4, correlation results 428-432 include three example correlations, including a correlation result 428 corresponding to reported financial activity correlated to financial activity using a first account. Another correlation result 430 corresponds to uncorrelated financial activity on the first account, while a further correlation result 432 corresponds to an uncorrelated new account.

Identifier and security action module 434 of example system 400 may receive correlation results 428-432 and act on these correlation results in accordance with various predetermined rules and/or preferences 422 and 424. For example, a predetermined rule may identify all uncorrelated activity, such as correlation results 430 and 432, as transactions initiated using an unauthorized device, and security actions 436 (e.g., alerts, account holds, and/or credit freezes) may be enacted based on predetermined rules and/or preferences 422 and/or 424. Alternatively or additionally, identification of the authorized activity may not occur if preferences 422 and/or 424 indicate that certain types of transactions (e.g., from a particular merchant and/or below a certain amount) should not be identified, or that no security action should be taken in response to such an identification. In another example, an account preference 422 specific to the first account may be applied in identifying a correlated activity as unauthorized based on one or more characteristics of the transaction (e.g., from a disallowed merchant and/or above a certain amount).

Use of account preferences 422 and 424 that are account-specific allows customers to customize behavior of example system 400 to accommodate customer preferences regarding various situations. For example, a customer may not have the antivirus and security software installed on all devices that the customer uses to make purchases using one or more of the accounts. Such a situation may occur if the customer has too many devices and not enough licenses and/or if the customer using an account on a device (e.g., a gaming console or a device of an employer of the customer) on which the customer is not authorized to install the antivirus and security software. In such cases, the customer may specify account preferences 422 specific to the first account to avoid generating alerts for purchases made from one or more merchants and/or below a certain amount. Customer feedback in response to security actions 436 may also be employed to generate such preferences 422 (e.g., adding a merchant to a whitelist for the first account and/or recording a minimum purchase price for causing a security action to occur).

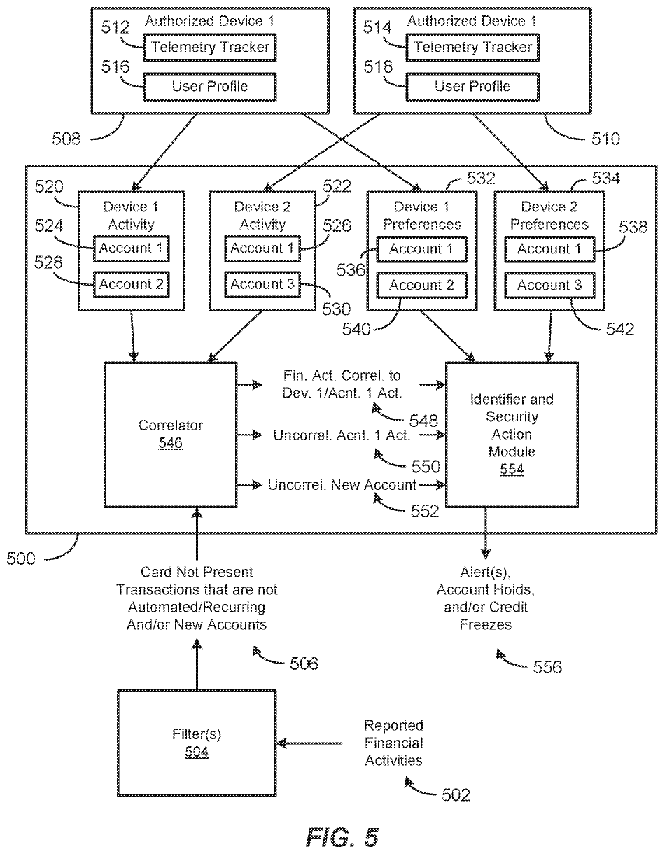

FIG. 5 illustrates an example system 500 for detecting unauthorized online transactions. Example system 500 has features that are similar to the features of example system 400, and it may have all of the functionality previously described with reference to example system 400. For example, elements 502-506, 546, and 550-552 of example system 500 may be substantially similar to elements 402-406, 426, and 430-436 of example system 400. However, example system 500 may accomplish device-specific accommodation of multiple authorized devices 508 and 510, each having telemetry trackers 512 and 514 and user profiles 516 and 518. This device-specific accommodation may be accomplished in part by receiving device activity 522 and 524 that is device-specific and that may also have account-specific activity 524-530 per device. The device-specific accommodation may further be accomplished in part by receiving device preferences 532 and 534 that are device-specific and that also may have account-specific preferences 536-542 per device.

Use of device activity 522 and 524 and device preferences 532 and 534 that are device-specific and account-specific allows customers to customize behavior of example system 500 to accommodate customer preferences regarding various situations. For example, given a device-specific and account-specific correlation result 548, preferences 536 that are device-specific and account-specific may cause identifier and security action module 554 to respond to correlation result 548 in various ways. In a first example, a customer may specify that use of an account is restricted on one of the devices (e.g., parental controls that allow only certain types of transactions (e.g., vendor and/or amount) on an account authorized for use by a child's device). In another example, a customer may express preferences for security actions to be taken for uncorrelated account activity, and the specified preferences may be different when the customer provides them on a different device. In this situation, example system 500 may allow the user to designate a master device for which these preferences should take priority when there is a conflict. Alternatively or additionally, example system 500 may apply the most recently provided preferences of this type as updated preferences.

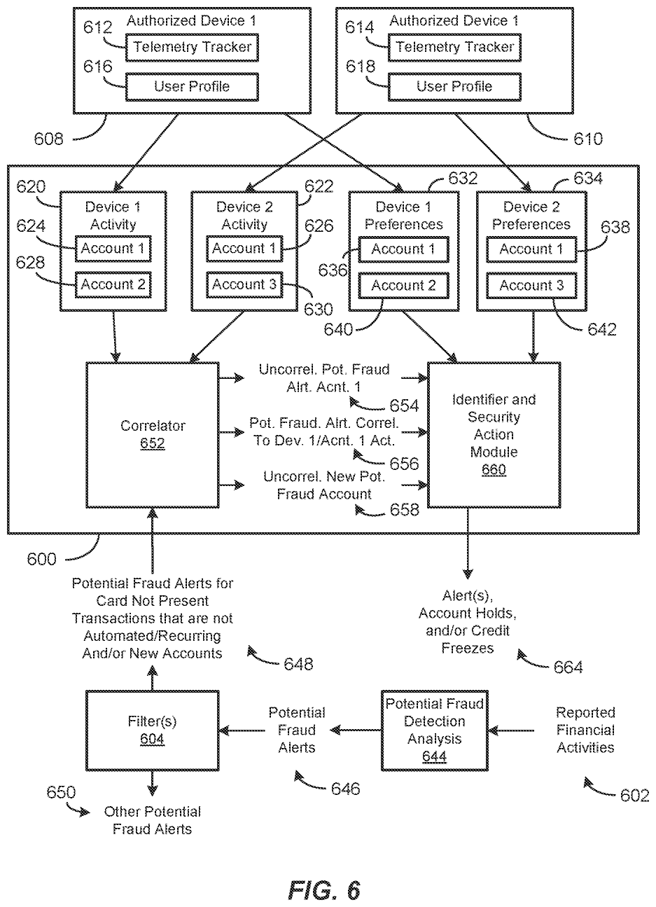

FIG. 6 illustrates an example system 600 for detecting unauthorized online transactions. Example system 600 has features that are similar to the features of example system 500. For example, elements 608-642 of example system 600 may be substantially similar to elements 508-542 of example system 500, and it may have all of the functionality previously described with reference to example system 500. However, example system 600 may be configured to filter and/or automatically confirm potential fraud alerts 646 generated by potential fraud detection analysis 644 (e.g., machine learning heuristics) implemented by systems and services that monitor for identity theft, the use of personal information, and credit score changes. In this case, reported financial activities 602 may be processed by potential fraud detection analysis 644 to produce potential fraud alerts 646. Such alerts 646 may ordinarily be confirmed by customers and preventative actions (e.g., account hold, charge reversal, or credit freeze) taken in response to confirmed fraud. Example system 600 allows filter results 648 from application of filters 604 to be further filtered by device activity 620 and 622 or automatically confirmed per device preferences 632 and 634.

Potential fraud alerts 650 that are filtered out because they are in-person, non-recurring transactions may be handled in the ordinary manner by issuing a potential fraud alert to a customer and seeking confirmation of fraud. However, filter results 648, which may contain potential fraud alerts for card-not-present transactions that are not recurring, may be received by correlator 652. Correlator 652 may operate on the same or similar principles as correlator 546 or correlator 426 as previously described. However, correlation results 654-658 are for reported transactions that have already been detected as potentially fraudulent. Device preferences 632 and 634 may automatically confirm fraud in some cases, while alerts of transactions that correlate to device activity 620 and 622 tracked by authorized devices 608 and 610 may be eliminated. Advantageously, the customer may avoid being contacted about such fraud alerts and fraud confirmation may be achieved more rapidly, resulting in a more rapid response (e.g., account holds and/or credit freezes).

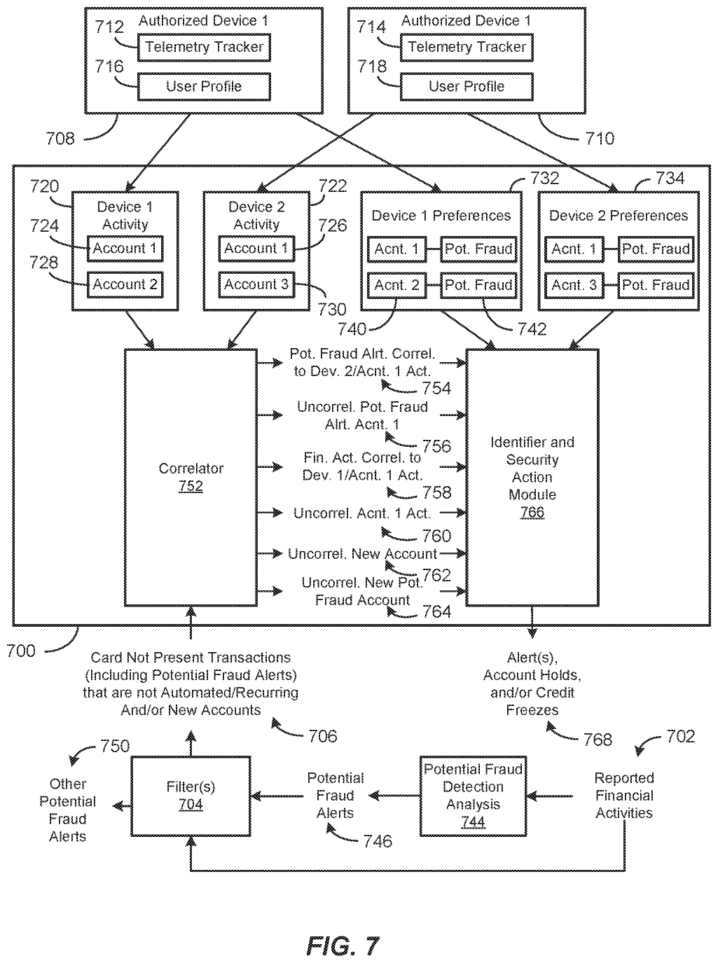

FIG. 7 illustrates an example system 700 for detecting unauthorized online transactions. Example system 700 has features that are similar to features of example systems 500 and 600, effectively combining the functionality of these systems. For example, elements 708-730 of example system 700 may be substantially similar to elements 508-530 of example system 500 and elements 608-630 of example system 600. However, correlator 752 of example system 700 may be configured to process filter results 706 that include potential fraud alerts in addition to other reported financial transactions that are neither in-person transactions nor recurring/automated transactions. In this case, filters 704 may filter both potential fraud alerts 746 and reported financial activities 702 processed by potential fraud detection analysis 744 to produce potential fraud alerts 746. Filters 704 may also filter from results 706 any transactions that are duplicates of the potential fraud alerts in filter results 706.

Correlator 752 may receive filter results 706 and produce correlation results 754-764 based on device activity 720 and 725. Examples of such results may include result 754, which corresponds to a potentially fraud alert correlated with activity 726 on a first account using second authorized device 710. Another example of such results may include result 756, which corresponds to an uncorrelated potential fraud alert on the first account. Another example of such results may include result 758, which corresponds to reported financial activity correlated with activity on the first account using first authorized device 708. Another example of such results may include result 760, which corresponds to an uncorrelated reported financial activity on the first account. Another example of such results may include result 762, which corresponds to an uncorrelated newly opened account. Another example of such results may include result 764, which corresponds to an uncorrelated potential fraud alert regarding a newly opened account.

Identifier and security action module 766 may, for results 758-762, perform the identification and take security actions using preferences 740 that are device-specific and account-specific as previously described with reference to example system 500. Identifier and security action module 766 may, for results 754, 756, and 764, perform the identification and take security actions using a different set of preferences 742 for potential fraud alerts, and these preferences may also be device-specific and account-specific as previously described with reference to example system 600. Accordingly, the security actions 768 enacted by system 700 may be customized by users who desire that different identification criteria be used and security responses taken on a device and account specific basis for correlation results 754-764 depending whether the results 754-764 are potential fraud alerts. In this way the advantages previously described for systems 400, 500, and 600 may be realized in combination.

As detailed herein, customers of systems and services that monitor for identity theft, the use of personal information, and credit score changes may benefit, in new and advantageous ways, from implementing antivirus and security services software on their authorized devices. For example, these customers may receive rapid alerts about any transactions undertaken using their financial accounts that were not initiated from a trusted device on which anti-virus and security software has correlated reported financial transactions to website purchases observed by network traffic monitoring. Users may receive such alerts by installing the anti-virus and security software on devices from which they regularly make financial transactions. The advantages may be realized by implementing three components: tracking of web-based financial transactions in network telemetry, identification of card-not-present reported financial transactions that correspond to online transactions, and the correlation of financial events tracked in network telemetry with reported financial transactions monitored by systems and services that monitor for identity theft, the use of personal information, and credit score changes.

FIG. 8 is a block diagram of an example computing system 810 capable of implementing one or more of the embodiments described and/or illustrated herein. For example, all or a portion of computing system 810 may perform and/or be a means for performing, either alone or in combination with other elements, one or more of the steps described herein (such as one or more of the steps illustrated in FIG. 3). All or a portion of computing system 810 may also perform and/or be a means for performing any other steps, methods, or processes described and/or illustrated herein.

Computing system 810 broadly represents any single or multi-processor computing device or system capable of executing computer-readable instructions. Examples of computing system 810 include, without limitation, workstations, laptops, client-side terminals, servers, distributed computing systems, handheld devices, or any other computing system or device. In its most basic configuration, computing system 810 may include at least one processor 814 and a system memory 816.

Processor 814 generally represents any type or form of physical processing unit (e.g., a hardware-implemented central processing unit) capable of processing data or interpreting and executing instructions. In certain embodiments, processor 814 may receive instructions from a software application or module. These instructions may cause processor 814 to perform the functions of one or more of the example embodiments described and/or illustrated herein.

System memory 816 generally represents any type or form of volatile or non-volatile storage device or medium capable of storing data and/or other computer-readable instructions. Examples of system memory 816 include, without limitation, Random Access Memory (RAM), Read Only Memory (ROM), flash memory, or any other suitable memory device. Although not required, in certain embodiments computing system 810 may include both a volatile memory unit (such as, for example, system memory 816) and a non-volatile storage device (such as, for example, primary storage device 832, as described in detail below). In one example, one or more of modules 102 from FIG. 1 may be loaded into system memory 816.

In some examples, system memory 816 may store and/or load an operating system 840 for execution by processor 814. In one example, operating system 840 may include and/or represent software that manages computer hardware and software resources and/or provides common services to computer programs and/or applications on computing system 810. Examples of operating system 840 include, without limitation, LINUX, JUNOS, MICROSOFT WINDOWS, WINDOWS MOBILE, MAC OS, APPLE'S IOS, UNIX, GOOGLE CHROME OS, GOOGLE'S ANDROID, SOLARIS, variations of one or more of the same, and/or any other suitable operating system.

In certain embodiments, example computing system 810 may also include one or more components or elements in addition to processor 814 and system memory 816. For example, as illustrated in FIG. 8, computing system 810 may include a memory controller 818, an Input/Output (I/O) controller 820, and a communication interface 822, each of which may be interconnected via a communication infrastructure 812. Communication infrastructure 812 generally represents any type or form of infrastructure capable of facilitating communication between one or more components of a computing device. Examples of communication infrastructure 812 include, without limitation, a communication bus (such as an Industry Standard Architecture (ISA), Peripheral Component Interconnect (PCI), PCI Express (PCIe), or similar bus) and a network.

Memory controller 818 generally represents any type or form of device capable of handling memory or data or controlling communication between one or more components of computing system 810. For example, in certain embodiments memory controller 818 may control communication between processor 814, system memory 816, and I/O controller 820 via communication infrastructure 812.

I/O controller 820 generally represents any type or form of module capable of coordinating and/or controlling the input and output functions of a computing device. For example, in certain embodiments I/O controller 820 may control or facilitate transfer of data between one or more elements of computing system 810, such as processor 814, system memory 816, communication interface 822, display adapter 826, input interface 830, and storage interface 834.

As illustrated in FIG. 8, computing system 810 may also include at least one display device 824 coupled to I/O controller 820 via a display adapter 826. Display device 824 generally represents any type or form of device capable of visually displaying information forwarded by display adapter 826. Similarly, display adapter 826 generally represents any type or form of device configured to forward graphics, text, and other data from communication infrastructure 812 (or from a frame buffer, as known in the art) for display on display device 824.

As illustrated in FIG. 8, example computing system 810 may also include at least one input device 828 coupled to I/O controller 820 via an input interface 830. Input device 828 generally represents any type or form of input device capable of providing input, either computer or human generated, to example computing system 810. Examples of input device 828 include, without limitation, a keyboard, a pointing device, a speech recognition device, variations or combinations of one or more of the same, and/or any other input device.

Additionally or alternatively, example computing system 810 may include additional I/O devices. For example, example computing system 810 may include I/O device 836. In this example, I/O device 836 may include and/or represent a user interface that facilitates human interaction with computing system 810. Examples of I/O device 836 include, without limitation, a computer mouse, a keyboard, a monitor, a printer, a modem, a camera, a scanner, a microphone, a touchscreen device, variations or combinations of one or more of the same, and/or any other I/O device.

Communication interface 822 broadly represents any type or form of communication device or adapter capable of facilitating communication between example computing system 810 and one or more additional devices. For example, in certain embodiments communication interface 822 may facilitate communication between computing system 810 and a private or public network including additional computing systems. Examples of communication interface 822 include, without limitation, a wired network interface (such as a network interface card), a wireless network interface (such as a wireless network interface card), a modem, and any other suitable interface. In at least one embodiment, communication interface 822 may provide a direct connection to a remote server via a direct link to a network, such as the Internet. Communication interface 822 may also indirectly provide such a connection through, for example, a local area network (such as an Ethernet network), a personal area network, a telephone or cable network, a cellular telephone connection, a satellite data connection, or any other suitable connection.

In certain embodiments, communication interface 822 may also represent a host adapter configured to facilitate communication between computing system 810 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 822 may also allow computing system 810 to engage in distributed or remote computing. For example, communication interface 822 may receive instructions from a remote device or send instructions to a remote device for execution.

In some examples, system memory 816 may store and/or load a network communication program 838 for execution by processor 814. In one example, network communication program 838 may include and/or represent software that enables computing system 810 to establish a network connection 842 with another computing system (not illustrated in FIG. 8) and/or communicate with the other computing system by way of communication interface 822. In this example, network communication program 838 may direct the flow of outgoing traffic that is sent to the other computing system via network connection 842. Additionally or alternatively, network communication program 838 may direct the processing of incoming traffic that is received from the other computing system via network connection 842 in connection with processor 814.

Although not illustrated in this way in FIG. 8, network communication program 838 may alternatively be stored and/or loaded in communication interface 822. For example, network communication program 838 may include and/or represent at least a portion of software and/or firmware that is executed by a processor and/or Application Specific Integrated Circuit (ASIC) incorporated in communication interface 822.

As illustrated in FIG. 8, example computing system 810 may also include a primary storage device 832 and a backup storage device 833 coupled to communication infrastructure 812 via a storage interface 834. Storage devices 832 and 833 generally represent any type or form of storage device or medium capable of storing data and/or other computer-readable instructions. For example, storage devices 832 and 833 may be a magnetic disk drive (e.g., a so-called hard drive), a solid state drive, a floppy disk drive, a magnetic tape drive, an optical disk drive, a flash drive, or the like. Storage interface 834 generally represents any type or form of interface or device for transferring data between storage devices 832 and 833 and other components of computing system 810. In one example, data storage 120 from FIG. 1 may be stored and/or loaded in primary storage device 832.

In certain embodiments, storage devices 832 and 833 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 832 and 833 may also include other similar structures or devices for allowing computer software, data, or other computer-readable instructions to be loaded into computing system 810. For example, storage devices 832 and 833 may be configured to read and write software, data, or other computer-readable information. Storage devices 832 and 833 may also be a part of computing system 810 or may be a separate device accessed through other interface systems.

Many other devices or subsystems may be connected to computing system 810. Conversely, all of the components and devices illustrated in FIG. 8 need not be present to practice the embodiments described and/or illustrated herein. The devices and subsystems referenced above may also be interconnected in different ways from that shown in FIG. 8. Computing system 810 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 810. All or a portion of the computer program stored on the computer-readable medium may then be stored in system memory 816 and/or various portions of storage devices 832 and 833. When executed by processor 814, a computer program loaded into computing system 810 may cause processor 814 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 810 may be configured as an Application Specific Integrated Circuit (ASIC) adapted to implement one or more of the example embodiments disclosed herein.

FIG. 9 is a block diagram of an example network architecture 900 in which client systems 910, 920, and 930 and servers 940 and 945 may be coupled to a network 950. As detailed above, all or a portion of network architecture 900 may perform and/or be a means for performing, either alone or in combination with other elements, one or more of the steps disclosed herein (such as one or more of the steps illustrated in FIG. 3). All or a portion of network architecture 900 may also be used to perform and/or be a means for performing other steps and features set forth in the present disclosure.

Client systems 910, 920, and 930 generally represent any type or form of computing device or system, such as example computing system 810 in FIG. 8. Similarly, servers 940 and 945 generally represent computing devices or systems, such as application servers or database servers, configured to provide various database services and/or run certain software applications. Network 950 generally represents any telecommunication or computer network including, for example, an intranet, a WAN, a LAN, a PAN, or the Internet. In one example, client systems 910, 920, and/or 930 and/or servers 940 and/or 945 may include all or a portion of system 100 from FIG. 1.

As illustrated in FIG. 9, one or more storage devices 960(1)-(N) may be directly attached to server 940. Similarly, one or more storage devices 970(1)-(N) may be directly attached to server 945. Storage devices 960(1)-(N) and storage devices 970(1)-(N) generally represent any type or form of storage device or medium capable of storing data and/or other computer-readable instructions. In certain embodiments, storage devices 960(1)-(N) and storage devices 970(1)-(N) may represent Network-Attached Storage (NAS) devices configured to communicate with servers 940 and 945 using various protocols, such as Network File System (NFS), Server Message Block (SMB), or Common Internet File System (CIFS).

Servers 940 and 945 may also be connected to a Storage Area Network (SAN) fabric 980. SAN fabric 980 generally represents any type or form of computer network or architecture capable of facilitating communication between a plurality of storage devices. SAN fabric 980 may facilitate communication between servers 940 and 945 and a plurality of storage devices 990(1)-(N) and/or an intelligent storage array 995. SAN fabric 980 may also facilitate, via network 950 and servers 940 and 945, communication between client systems 910, 920, and 930 and storage devices 990(1)-(N) and/or intelligent storage array 995 in such a manner that devices 990(1)-(N) and array 995 appear as locally attached devices to client systems 910, 920, and 930. As with storage devices 960(1)-(N) and storage devices 970(1)-(N), storage devices 990(1)-(N) and intelligent storage array 995 generally represent any type or form of storage device or medium capable of storing data and/or other computer-readable instructions.

In certain embodiments, and with reference to example computing system 810 of FIG. 8, a communication interface, such as communication interface 822 in FIG. 8, may be used to provide connectivity between each client system 910, 920, and 930 and network 950. Client systems 910, 920, and 930 may be able to access information on server 940 or 945 using, for example, a web browser or other client software. Such software may allow client systems 910, 920, and 930 to access data hosted by server 940, server 945, storage devices 960(1)-(N), storage devices 970(1)-(N), storage devices 990(1)-(N), or intelligent storage array 995. Although FIG. 9 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 940, server 945, storage devices 960(1)-(N), storage devices 970(1)-(N), storage devices 990(1)-(N), intelligent storage array 995, or any combination thereof. All or a portion of one or more of the example embodiments disclosed herein may also be encoded as a computer program, stored in server 940, run by server 945, and distributed to client systems 910, 920, and 930 over network 950.

As detailed above, computing system 810 and/or one or more components of network architecture 900 may perform and/or be a means for performing, either alone or in combination with other elements, one or more steps of an example method for detecting unauthorized online transactions.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. For example, one or more of the modules recited herein may receive financial activity data to be transformed, transform the financial activity data, output a result of the transformation to provide correlation results, use the result of the transformation to identify transactions initiated on unauthorized devices, and store the result of the transformation to trigger a security action. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for detecting unauthorized online transactions, at least a portion of the method being performed by a computing device comprising at least one processor, the method comprising:
correlating, by the at least one processor, one or more reported financial activities to one or more online financial activities tracked in network telemetry on one or more authorized devices;
identifying, by the at least one processor based on the correlation, at least one of the reported financial activities that was initiated by an unauthorized device; and
performing, by the at least one processor, a security action in response to the identification.

2. The method of claim 1, wherein the one or more reported financial activities correspond to one or more card-not-present financial transactions of an account and the one or more online financial activities correspond to one or more web-based financial transactions tracked in network telemetry on at least one of the one or more of the authorized devices that are authorized to perform online purchases using the account.

3. The method of claim 1, wherein the one or more reported financial activities correspond to one or more new accounts appearing on a credit report of a user and the one or more online financial activities correspond to one or more account opening activities tracked in network telemetry on at least one of the one or more authorized devices that are authorized to open new accounts on behalf of the user.

4. The method of claim 1, further comprising:
tracking the one or more online financial activities on at least one of the authorized devices that is authorized to perform the online financial activities.

5. The method of claim 1, further comprising:
identifying the one or more reported financial activities.

6. The method of claim 1, further comprising:
filtering, from the one or more reported financial activities, at least one of automated recurring transactions or transactions that do not correspond to card-not-present transactions.

7. The method of claim 1, wherein performing the security action includes at least one of issuing an alert or taking a preventative action.

8. The method of claim 7, wherein issuing the alert includes at least one of generating an alert in response to the identifying or issuing a potential fraud alert generated based on a fraud detection analysis of the one or more reported financial activities.

9. The method of claim 7, wherein taking the preventative action includes at least one of placing a hold on an account or performing an automated credit freeze.

10. A system for detecting unauthorized online transactions, the system comprising:
at least one physical processor;
physical memory comprising computer-executable instructions that, when executed by the physical processor, cause the physical processor to:
correlate one or more reported financial activities to one or more online financial activities tracked in network telemetry on one or more authorized devices;
identify, based on the correlation, at least one of the reported financial activities that was initiated by an unauthorized device; and
perform a security action in response to the identification.

11. The system of claim 10, wherein the one or more reported financial activities correspond to one or more card-not-present financial transactions of an account and the one or more online financial activities correspond to one or more web-based financial transactions tracked in network telemetry on at least one of the one or more of the authorized devices that are authorized to perform online purchases using the account.

12. The system of claim 10, wherein the one or more reported financial activities correspond to one or more new accounts appearing on a credit report of a user and the one or more online financial activities correspond to one or more account opening activities tracked in network telemetry on at least one of the one or more authorized devices that are authorized to open new accounts on behalf of the user.

13. The system of claim 10, wherein the computer-executable instructions further cause the physical processor to:
track the one or more online financial activities on at least one of the authorized devices that is authorized to perform the online financial activities.

14. The system of claim 10, wherein the computer-executable instructions further cause the physical processor to:
identify the one or more reported financial activities.

15. The system of claim 10, wherein the computer-executable instructions further cause the physical processor to:
filter, from the one or more reported financial activities, at least one of automated recurring transactions or transactions that do not correspond to card-not-present transactions.

16. The system of claim 10, wherein performing the security action includes at least one of issuing an alert or taking a preventative action.

17. A non-transitory computer-readable medium comprising one or more computer-executable instructions that, when executed by at least one processor of a computing device, cause the computing device to:
correlate one or more reported financial activities to one or more online financial activities tracked in network telemetry on one or more authorized devices;
identify, based on the correlation, at least one of the reported financial activities that was initiated by an unauthorized device; and
perform a security action in response to the identification.

18. The non-transitory computer-readable medium of claim 17, wherein the one or more reported financial activities correspond to one or more card-not-present financial transactions of an account and the one or more online financial activities correspond to one or more web-based financial transactions tracked in network telemetry on at least one of the one or more of the authorized devices that are authorized to perform online purchases using the account.

19. The non-transitory computer-readable medium of claim 17, wherein the one or more reported financial activities correspond to one or more new accounts appearing on a credit report of a user and the one or more online financial activities correspond to one or more account opening activities tracked in network telemetry on at least one of the one or more authorized devices that are authorized to open new accounts on behalf of the user.

20. The non-transitory computer-readable medium of claim 17, wherein the computer-executable instructions further cause the physical processor to:
filter, from the one or more reported financial activities, at least one of automated recurring transactions or transactions that do not correspond to card-not-present transactions.
